(19) United States
(12) Patent Application Publication
(10) Pub. No.: US 2026/0182508 A1
(43) Pub. Date: Jul. 2, 2026

(54) PENETRATING SOIL WATERING DEVICE

(71) Applicant: Raymond Guardado, Bend, OR (US)

(72) Inventor: Raymond Guardado, Bend, OR (US)

(21) Appl. No.: 19/002,108

(22) Filed: Dec. 26, 2024

(51) Int. Cl. A01G 29/00; A01G 25/14

(52) U.S. Cl. CPC A01G 29/00; A01G 25/14

(57) ABSTRACT

A penetrating soil watering device includes a box which has a plurality of watering holes to release the water from the box. A plurality of spikes is each releasably attachable to the box to penetrate the ground when the user stands on the box. Each of the spikes receives the water from the box. Each of the spikes has a plurality of watering outlets to release the water to roots of grass that is growing in the ground when the plurality of spikes penetrates the ground. A first pipe is coupled to the box and a second pipe is disposed on the first pipe which is attachable to a water source to deliver the water into the first pipe. A water valve is integrated into the second pipe either to inhibit the water from flowing into the first pipe or to allow the water to flow into the first pipe.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to soil watering devices and more particularly pertains to a new soil watering device for directly watering roots of grass and other plants. The device includes a box upon which a user can stand and first pipe extending upwardly from the box and a second pipe that is attached to the first pipe which can be coupled to a water source to deliver water into the box. The device includes a plurality of spikes that are releasably attachable to box to penetrate the ground when the user stands upon the box. Each of the plurality of spikes is foraminous to release the water into the ground to hydrate roots of grass growing in the ground. The device includes a water valve that is integrated into the second pipe to either inhibit the flow of water into the box or allow the flow of water into the box.

### (2) Description of Related Art Including Information Disclosed Under 37 CFR 1.97 and 1.98

The prior art relates to soil watering devices including: a variety of root feeder devices that each at least includes a pointed pipe which can be pushed into the ground and a water valve attached to the pipe which can be coupled to a water source to deliver water through the pointed pipe to hydrate roots of plants; a lawn renovating tool which includes an elongate handle and a soil breaking device attached to the handle for breaking soil and a feeder tube which is in fluid communication with the soil breaking device to deliver water from a water source; a water dispersing device that includes a plurality perforated spikes which can be pushed into the ground and which can each be coupled to a water source for hydrating roots of a plant; an irrigation system that includes a plurality of perforated spikes which can each be pushed into ground which each includes a clamp that engages and punctures a water hose to deliver water into each of the plurality of perforated spikes to hydrate roots of plants; an ornamental design for a lawn aeration tool that includes a handle and a base attached to the handle and a plurality of spikes extending downwardly from the base for penetrating and aerating soil. In no instance does the prior art disclose a penetrating soil watering device that includes a box upon which a user can stand and a plurality of perforated spikes which are releasably attachable to the box to penetrate ground and first pipe attached to the box and a second pipe attached to the first pipe, which can be coupled to a water source to deliver water into each of the plurality of perforated spikes, and a water valve integrated into the second pipe.

### (h) Brief Summary of the Invention

An embodiment of the disclosure meets the needs presented above by generally comprising a box which has a plurality of watering holes to release the water from the box. A plurality of spikes is each releasably attachable to the box to penetrate the ground when the user stands on the box. Each of the spikes receives the water from the box. Each of the spikes has a plurality of watering outlets to release the water to roots of grass that is growing in the ground when the plurality of spikes penetrates the ground. A first pipe is coupled to the box and a second pipe is disposed on the first pipe which is attachable to a water source to deliver the water into the first pipe. A water valve is integrated into the second pipe either to inhibit the water from flowing into the first pipe or to allow the water to flow into the first pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a penetrating soil watering device according to an embodiment of the disclosure.

FIG. 2 is a front view of an embodiment of the disclosure.

FIG. 3 is a left side view of an embodiment of the disclosure.

FIG. 4 is a cross sectional view taken along line 4-4 of FIG. 2 of an embodiment of the disclosure.

FIG. 5 is a cross sectional view taken along line 5-5 of FIG. 3 of an embodiment of the disclosure.

FIG. 6 is a perspective in-use view of an embodiment of the disclosure.

FIG. 7 is a bottom view of an embodiment of the disclosure.

### (J) DETAILED DESCRIPTION OF THE INVENTION

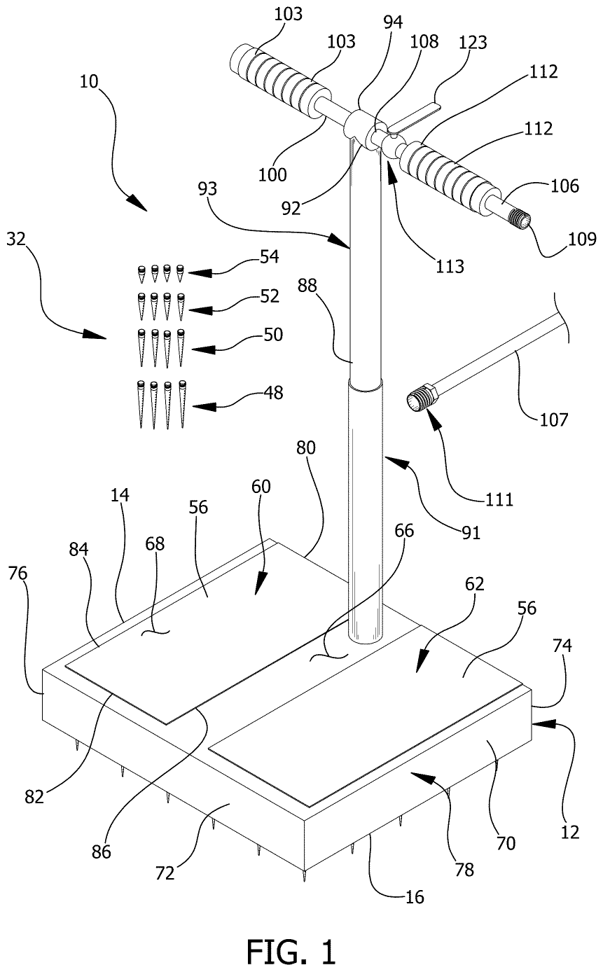

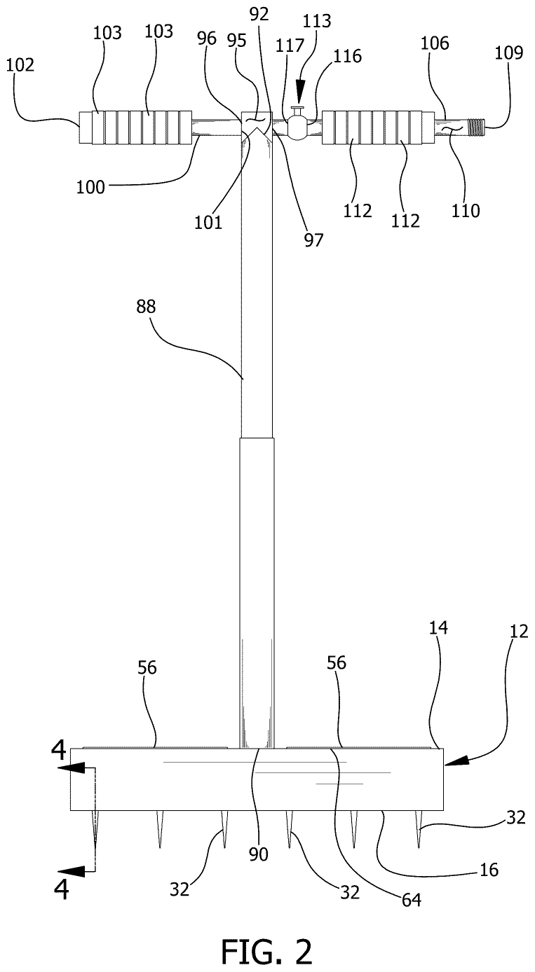

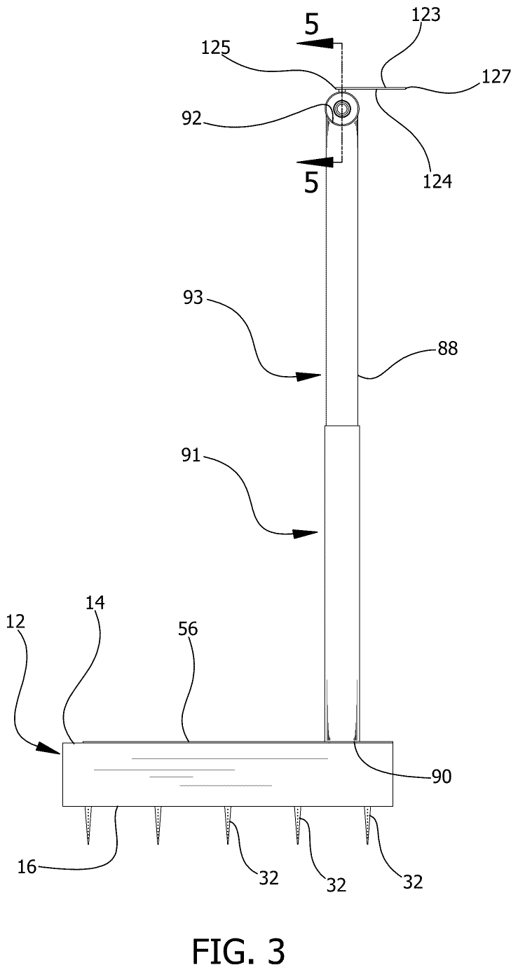

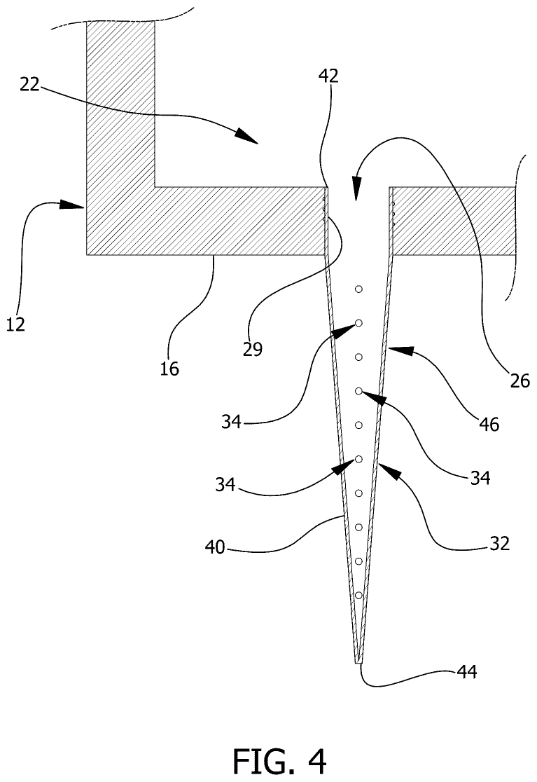

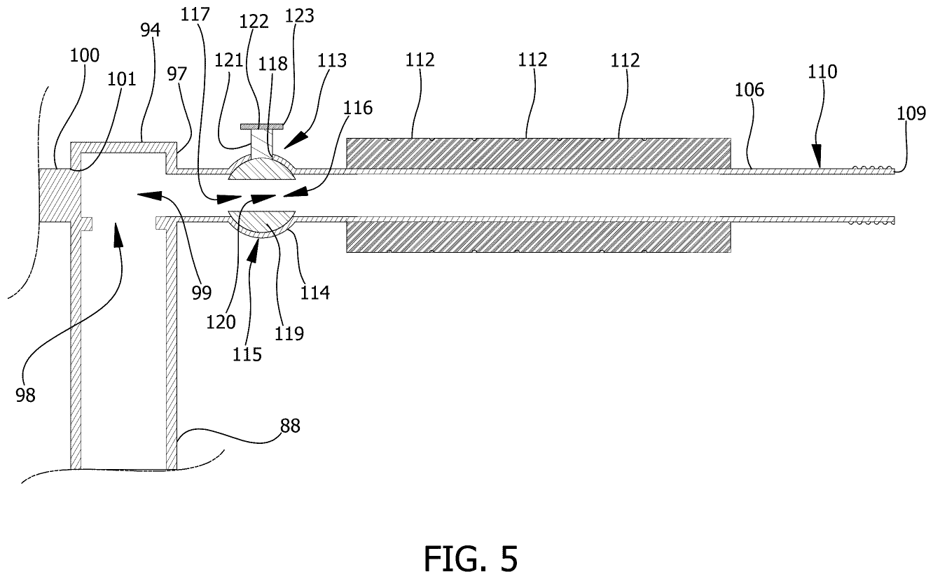

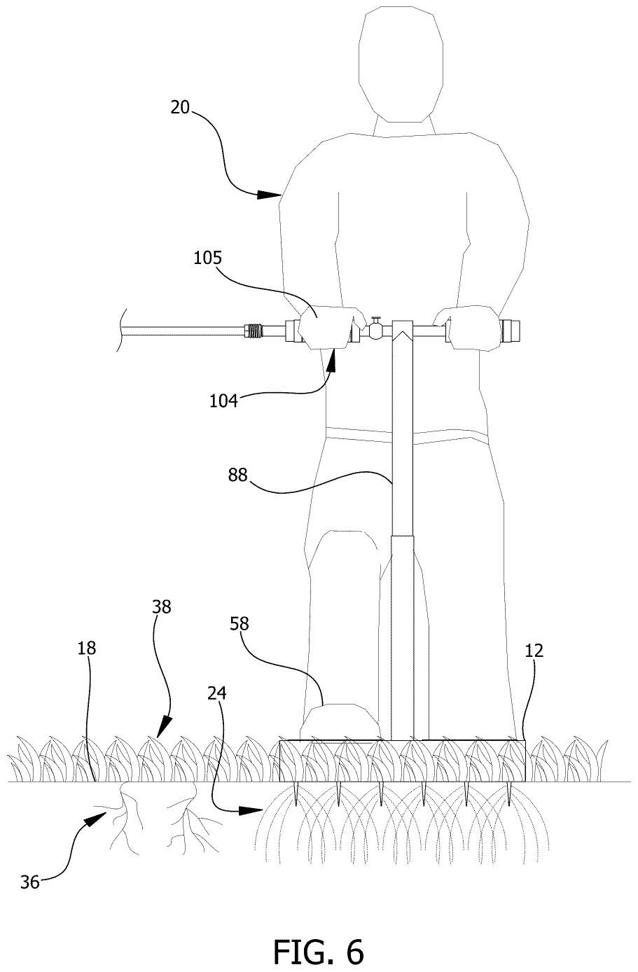

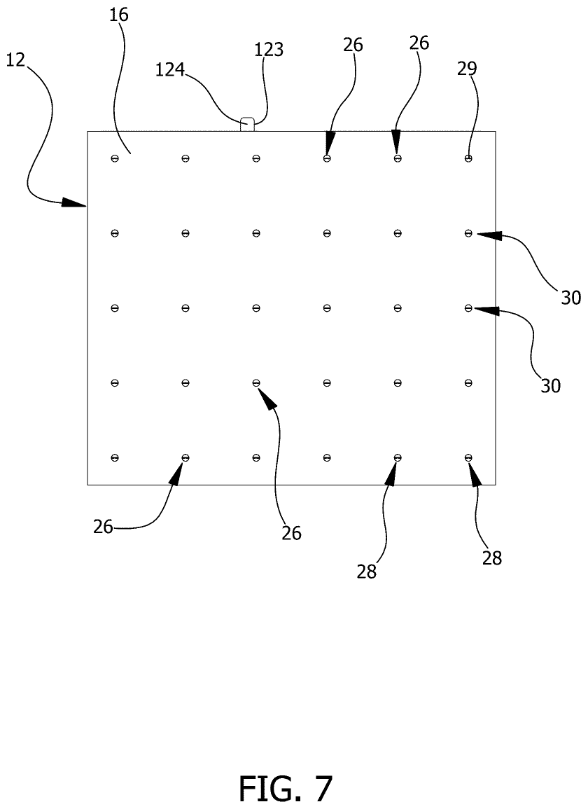

With reference now to the drawings, and in particular to FIGS. 1 through 7 thereof, a new soil watering device embodying the principles and concepts of an embodiment of the disclosure and generally designated by the reference numeral 10 will be described.

As best illustrated in FIGS. 1 through 7, the penetrating soil watering device 10 generally comprises a box 12 that has a top wall 14 and a bottom wall 16; the bottom wall 16 can be placed on the ground 18 such that a user 20 can stand on the top wall 14. The box 12 is hollow to define a water space 22 within the box 12 which can contain water 24. The box 12 has a plurality of watering holes 26 each extending through the bottom wall 16 and into the water space 22 such that the plurality of watering holes 26 can release the water 24 from the water space 22. Additionally, the plurality of watering holes 26 is arranged in a plurality of columns 28 and rows 30 on the bottom wall 16 and each watering hole 26 of the plurality of watering holes 26 has a bounding edge 29 which is threaded. Furthermore, the box 12 may have a length ranging between approximately 76.0 cm and 90.0 cm and a width ranging between approximately 65.0 cm and 75.0 cm and a height ranging between approximately 5.0 cm and 7.0 cm.

A plurality of spikes 32 is provided and each spike 32 of the plurality of spikes 32 is releasably attachable to the bottom wall 16 of the box 12 such that each spike 32 of the plurality of spikes 32 penetrates the ground 18 when the user 20 stands on the top wall 14 of the box 12. Each spike 32 of the plurality of spikes 32 is hollow such that each spike 32 of the plurality of spikes 32 is in fluid communication with the water space 22 when each spike 32 of the plurality of spikes 32 is releasably attached to the bottom wall 16 to receive the water 24 from the water space 22. Furthermore, each spike 32 of the plurality of spikes 32 has a plurality of watering outlets 34 to release the water 24 into the ground 18 such that the water 24 is delivered to roots 36 of grass 38 that is growing in the ground 18 when the plurality of spikes 32 penetrates the ground 18. The ground 18 may be located on a golf course or a sporting stadium or a lawn of a residence, for example, and the grass 38 may be grass of a fairway of the golf course or grass of a putting green on the golf course or grass in the sporting stadium or grass in the lawn of the residence. Additionally, the user 20 may be a groundskeeper of the golf course or a groundskeeper of the stadium or a homeowner.

Each spike 32 of the plurality of spikes 32 has an outside wall 40 extending between a top end 42 and a bottom end 44 of a respective spike 32; the top end 42 of each of spike 32 of the plurality of spikes 32 is open. The outside wall 40 of each spike 32 of the plurality of spikes 32 tapers between the top end 42 and the bottom end 44 such that the bottom end 44 of each spike 32 of the plurality of spikes 32 defines a point to penetrate the ground 18. An outside surface 46 of the outside wall 40 of each spike 32 of the plurality of spikes 32 is threaded adjacent to the top end 42. The top end 42 of each spike 32 of the plurality of spikes 32 is insertable into a respective one of the plurality of watering holes 26 in the bottom wall 16 of the box 12. Furthermore, the outside surface 46 of the outside wall 40 of each spike 32 of the plurality of spikes 32 threadably engages the bounding edge 29 of the respective watering hole 26 for releasably attaching each spike 32 of the plurality of spikes 32 to the bottom wall 16 of the box 12. Each watering outlet 34 of the plurality of watering outlets 34 associated with a respective one of the plurality of spikes 32 extends through the outside wall 40 of the respective spike 32. Additionally, the plurality of watering outlets 34 associated with the respective spike 32 is evenly spaced apart from each other and is distributed between the bottom end 44 and the top end 42 of the respective spike 32.

The plurality of spikes 32 includes a plurality of first spikes 48 and a plurality of second spikes 50 and a plurality of third spikes 52 and a plurality of fourth spikes 54 and a plurality of fifth spikes 55. The plurality of third spikes 52 has a length which is greater than a length of the plurality of fourth spikes 54. Additionally, the plurality of second spikes 50 has a length that is greater than the length of the plurality of third spikes 52. The plurality of first spikes 48 has a length that is greater than the length of the plurality of second spikes 50. The plurality of first spikes 48 may each have a length ranging between approximately 10.0 cm and 12.0 cm and the plurality of second spikes 50 may have a length ranging between approximately 7.0 cm and 9.0 cm. The plurality of third spikes 52 may have a length ranging between approximately 5.0 cm and 7.0 cm and 3the plurality of fourth spikes 54 may have a length ranging between approximately 2.0 cm and 4.0 cm. The plurality of first spikes 48 or the plurality of second spikes 50 or the plurality of third spikes 52 or the plurality of fourth spikes 54 are selected to be coupled to the bottom wall 16 of the box 12 depending upon the depth of the roots 36 of the grass 38 that is being watered.

A pair of foot pads 56 is each coupled to the top wall 14 of the box 12 such that a respective foot 58 of the user 20 can placed upon a respective foot pad 56 when the user 20 stands upon the top wall 14 of the box 12. Each foot pad 56 of the pair of foot pads 56 is comprised of a friction enhancing material, including but not being limited to rubber or grip tape, to inhibit the respective foot 58 of the user 20 from slipping on the respective foot pad 56 when the user 20 stands on the pair of foot pads 56. The pair of foot pads 56 includes a first foot pad 60 and a second foot pad 62. Each of the first foot pad 60 and the second foot pad 62 has a lower surface 64 which is coupled to a top surface 66 of the top wall 14 of the box 12 such that the respective foot 58 of the user 20 can be placed upon an upper surface 68 of a respective one of the first foot pad 60 and the second foot pad 62 when the user 20 stands on the top wall 14 of the box 12.

The box 12 has an outer wall 70 extending between the top wall 14 and the bottom wall 16; the outer wall 70 has a back side 72 and a front side 74 and a first lateral side 76 and a second lateral side 78. Each of the first foot pad 60 and the second foot pad 62 has a rear edge 80 and a front edge 82 and a first lateral edge 84 and a second lateral edge 86. The rear edge 80 of each of the first foot pad 60 and the second foot pad 62 is aligned with the front side 74 of the outer wall 70 of the box 12 and the front edge 82 of each of the first foot pad 60 and the second foot pad 62 is spaced from the back side 72 of the outer wall 70. The first lateral edge 84 of the first foot pad 60 is spaced from and is oriented parallel to the first lateral side 76 of the outer wall 70 of the box 12 and the second lateral edge 86 of the second foot pad 62 is spaced from and is oriented parallel to the second lateral side 78 of the outer wall 70 of the box 12. Furthermore, the second lateral edge 86 of the first foot pad 60 is spaced from and is oriented parallel to the first lateral edge 84 of the second foot pad 62.

A first pipe 88 is coupled to and extends upwardly from the top wall 14 of the box 12. The first pipe 88 is in fluid communication with the water space 22 in the box 12 such that the first pipe 88 can deliver water 24 into the water space 22. The first pipe 88 has a bottom end 90 which is centrally located between the second lateral edge 86 of the first foot pad 60 and the first lateral edge 84 of the second foot pad 62 such that the first pipe 88 is positioned between each foot 58 of the user 20 when the user 20 stands on the first foot pad 60 and the second foot pad 62. Additionally, the bottom end 90 of the first pipe 88 is spaced approximately 25.0 cm from the front side 74 of the outer wall 70 of the box 12 such that the first pipe 88 is positioned in front of the user 20 when the user 20 stands on the first foot pad 60 and the second foot pad 62. The first pipe 88 has a top end 92 that is concavely arcuate along an axis extending between the back side 72 and the front side 74 of the outer wall 70 of the box 12. Additionally, the first pipe 88 comprises a lower portion 91 that slidably receives an upper portion 93 such that the first pipe 88 has a telescopically adjustable height.

A cylinder 94 is provided which has an outer surface 95 extending between a first end 96 of the cylinder 94 and a second end 97 of the cylinder 94. The outer surface 95 is coupled to the top end 92 of the first pipe 88 such that the top end 92 of the first pipe 88 conforms to curvature of the outer surface 95. Furthermore, the cylinder 94 is oriented such that an axis extending between the first end 96 and the second end 97 is perpendicular to an axis extending between the top end 92 of the first pipe 88 and the bottom end 90 of the first pipe 88. The cylinder 94 is hollow and the cylinder 94 has a first hole 98 extending through the outer surface 95. The first hole 98 is aligned with the top end 92 of the first pipe 88 such that the an interior of the cylinder 94 is in fluid communication with an interior of the first pipe 88. The second end 97 of the cylinder 94 has a second hole 99 extending into the interior of the cylinder 94 such that the second hole 99 is in fluid communication with the interior of the first pipe 88.

A rod 100 is disposed on the first pipe 88 such that the rod 100 is spaced upwardly from the box 12. Additionally, the rod 100 is oriented perpendicular to the first pipe 88 such that the rod 100 can be gripped with a respective hand 105 of the user 20 when the user 20 stands on the pair of foot pads 56. The rod 100 has a coupled end 101 which is coupled to the first end 96 of the cylinder 94 such that the rod 100 is oriented to be colinear with an axis extending between the first end 96 of the cylinder 94 and the second end 97 of the cylinder 94; the rod 100 has a distal end 102 with respect to the first end 96 of the cylinder 94. A plurality of first annular rings 103 provided and each first annular ring 103 of the plurality of first annular rings 103 extends around the rod 100. The plurality of first annular rings 103 is distributed from the distal end 102 of the rod 100 toward the coupled end 101 of the rod 100 such that fingers 104 on a respective hand 105 of the user 20 can be wrapped around the plurality of first annular rings 103. Furthermore, the plurality of first annular rings 103 is comprised of a resiliently compressible material, including but not being limited to rubber or silicone, to enhance comfort for the user 20 when the fingers 104 on the respective hand 105 of the user 20 are wrapped around the plurality of first annular rings 103.

A second pipe 106 is disposed on the first pipe 88 such that the second pipe 106 is spaced upwardly from the box 12. The second pipe 106 is oriented perpendicular to the first pipe 88 such that the second pipe 106 can be gripped with a respective hand 105 of the user 20 when the user 20 stands on the pair of foot pads 56. The second pipe 106 is attachable to a water source 107, such as a garden hose for example, to receive water 24 from the water source 107. Additionally, a liquid fertilizer dispenser can be fluidly attached between the water source 107 and the second pipe 106 to mix liquid fertilizer into the water 24. The second pipe 106 is in fluid communication with the first pipe 88 to deliver the water 24 into the first pipe 88.

The second pipe 106 has a coupled end 108 which is coupled to the second end 97 of the cylinder 94 having the coupled end 108 of the second pipe 106 being aligned with the second hole 99 in the second end 97 of the cylinder 94. The coupled end 108 of the second pipe 106 delivers the water 24 into the second hole 99 such that the water 24 flows through the first hole 98 in the outer surface 95 of the cylinder 94 and into the top end 42 of the first pipe 88. The second pipe 106 has a distal end 109 with respect to the second end 97 of the cylinder 94 and the second pipe 106 has an outside surface 110. The outside surface 110 is threaded adjacent to the distal end 109 of the second pipe 106 such that the outside surface 110 can threadably engage a hose coupler 111 on the water source 107.

A plurality of second annular rings 112 is provided and each second annular ring 112 of the plurality of second annular rings 112 extends around the second pipe 106. The plurality of second annular rings 112 is positioned between the distal end 109 of the second pipe 106 and the coupled end 108 of the second pipe 106 such that fingers 104 on a respective hand 105 of the user 20 can be wrapped around the plurality of second annular rings 112. The plurality of second annular rings 112 is comprised of a resiliently compressible material, including but not being limited to rubber or silicone, to enhance comfort for the user 20 when the fingers 104 on the respective hand of the user 20 are wrapped around the plurality of second annular rings 112.

A water valve 113 is integrated into the second pipe 106 and the water valve 113 is actuatable into a closed condition to inhibit the water 24 from flowing through the water valve 113 to inhibit the water 24 from flowing into the first pipe 88. Conversely, the water valve 113 is actuatable into an open condition to allow the water 24 to flow through the water valve 113 such that the water 24 can flow into the first pipe 88. The water valve 113 comprises a housing 114 which has an exterior wall 115 that is continuously arcuate about a center point of the housing 114 such that the housing 114 has a ball shape. The housing 114 is integrated into the second pipe 106 at a point located between the plurality of second annular rings 112 and the coupled end 108 of the second pipe 106.

The housing 114 is hollow and the housing 114 has an entrance 116 extending through the exterior wall 115. The entrance 116 is in fluid communication with an interior of the second pipe 106 to pass the water 24 into the housing 114. The housing 114 has an exit 117 extending through the exterior wall 115 and the exit 117 is positioned on an opposite side of the exterior wall 115 with respect to the entrance 116. Furthermore, the exit 117 is in fluid communication with the interior of the second pipe 106 to pass the water 24 out of the housing 114. The exterior wall 115 has a stem hole 118 extending into the housing 114 and the stem hole 118 is located between the entrance 116 and the exit 117 having the stem hole 118 being aligned with an apex of the exterior wall 115 with respect to the entrance 116 and the exit 117.

The water valve 113 includes a ball 119 which is rotatably positioned within the housing 114 and the ball 119 has a channel 120 which extends through the ball 119. The ball 119 is rotatable into a first position having the channel 120 extending between the entrance 116 and the exit 117 such that the channel 120 passes the water 24 from the entrance 116 to the exit 117. The ball 119 is rotatable into a second position having the channel 120 being offset with each of the entrance 116 and the exit 117 to inhibit the water 24 from passing from the entrance 116 to the exit 117.

The water valve 113 includes a stem 121 that is coupled to the ball 119 and extends through the stem hole 118 in the exterior wall 115 of the housing 114. Additionally, the stem 121 has a top end 122 which is exposed with respect to the exterior wall 115. The water valve 113 includes a lever 123 which has a lower side 124 extending between a primary end 125 and a secondary end 126 of the lever 123. The lower side 124 is coupled to the top end 122 of the stem 121 at a point which is aligned with the primary end 125 such that the lever 123 is oriented perpendicular to the stem 121. Furthermore, the lever 123 can be gripped by the user 20 for rotating the ball 119 between the first position and the second position.

In use, either the plurality of first spikes 48 or the plurality of second spikes 50 or the plurality of third spikes 52 or the plurality of fourth spikes 54 is attached to the box 12, depending upon the desires of the user 20 and the expected depth of the roots 36 of the grass 38. The water source 107 is attached to the second pipe 106 and the box 12 is positioned on the ground 18 at a location where the grass 38 is dry or is in need of being fertilized. The user 20 stands on each of the pair of foot pads 56 to urge the plurality of spikes 32 to penetrate into the ground 18. The lever 123 on the water valve 113 is manipulated to position the water valve 113 in the open condition such that the water 24 flows outwardly through the watering outlets 34 in each of the plurality of spikes 32. Furthermore, the watering outlets 34 in each of the plurality of spikes 32 enables the water 24 to be released beneath the ground 18 to ensure the roots 36 of the grass 38 are watered in a manner that is superior to applying the water 24 on top of the ground 18 which requires the water 24 to seep into the ground 18. Additionally, the user 20 is not required to take a core sample of the ground 18 to confirm adequate saturation of the ground 18, which is a time consuming and arduous process. The lever 123 on the water valve 113 is manipulated to position the water valve 113 in the closed condition thereby stopping the flow of water 24 from the plurality of spikes 32 and the box 12 is transported to the next spot on the ground 18 for watering.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A penetrating soil watering device for watering dry spots in a grassy area, said device comprising:
a box having a top wall and a bottom wall wherein said bottom wall is configured to be placed on the ground such that a user can stand on said top wall, said box being hollow to define a water space within said box wherein said water space is configured to contain water, said box having a plurality of watering holes each extending through said bottom wall and into said water space wherein said plurality of watering holes is configured to release the water from said water space;
a plurality of spikes, each spike of said plurality of spikes being releasably attachable to said bottom wall of said box wherein each spike of said plurality of spikes is configured to penetrate the ground when the user stands on said top wall of said box, each spike of said plurality of spikes being hollow such that each spike of said plurality of spikes is in fluid communication with said water space when each spike of said plurality of spikes is releasably attached to said bottom wall wherein each spike of said plurality of spikes is configured to receive the water from said water space, each spike of said plurality of spikes having a plurality of watering outlets wherein said plurality of watering outlets in each spike of said plurality of spikes is configured to release the water into the ground such that the water is delivered to roots of grass that is growing in the ground when said plurality of spikes penetrates the ground;
a pair of foot pads, each foot pad of said pair of foot pads being coupled to said top wall of said box wherein each foot pad of said pair of foot pads is configured to have a respective foot of the user placed upon a respective foot pad when the user stands upon said top wall of said box, each foot pad of said pair of foot pads being comprised of a friction enhancing material wherein each foot pad of said pair of foot pads is configured to inhibit the respective foot of the user from slipping on said respective foot pad when the user stands on said pair of foot pads;
a first pipe being coupled to and extending upwardly from said top wall of said box, said first pipe being in fluid communication with said water space in said box wherein said first pipe is configured to deliver water into said water space;
a rod being disposed on said first pipe such that said rod is spaced upwardly from said box, said rod being oriented perpendicular to said first pipe wherein said rod is configured to be gripped with a respective hand of the user when the user stands on said pair of foot pads;
a second pipe being disposed on said first pipe such that said second pipe is spaced upwardly from said box, said second pipe being oriented perpendicular to said first pipe wherein said second pipe is configured to be gripped with a respective hand of the user when the user stands on said pair of foot pads, said second pipe being attachable to a water source wherein said second pipe is configured to receive water from the water source, said second pipe being in fluid communication with said first pipe wherein said second pipe is configured to deliver the water into said first pipe; and
a water valve being integrated into said second pipe, said water valve being actuatable into a closed condition wherein said water valve is configured to inhibit the water from flowing through said water valve to inhibit the water from flowing into said first pipe, said water valve being actuatable into an open condition wherein said water valve is configured to allow the water to flow through said water valve such that the water can flow into said first pipe.

2. The penetrating soil watering device according to claim 1, wherein said plurality of watering holes is arranged in a plurality of columns and rows on said bottom wall.

3. The penetrating soil watering device according to claim 1, wherein:
each watering hole of said plurality of watering holes has a bounding edge being threaded;
each spike of said plurality of spikes has an outside wall extending between a top end and a bottom end of a respective spike;
said top end of each of spike of said plurality of spikes is open;
an outside surface of said outside wall of each spike of said plurality of spikes is threaded adjacent to said top end;
said top end of each spike of said plurality of spikes is insertable into a respective one of said plurality of watering holes in said bottom wall of said box; and
said outside surface of said outside wall of each spike of said plurality of spikes threadably engages said bounding edge of said respective watering hole for releasably attaching each spike of said plurality of spikes to said bottom wall of said box.

4. The penetrating soil watering device according to claim 1, wherein
each spike of said plurality of spikes has an outside wall extending between a top end and a bottom end of a respective spike;
each watering outlet of said plurality of watering outlets associated with a respective one of said plurality of spikes extends through said outside wall of said respective spike; and
said plurality of watering outlets associated with said respective spike is evenly spaced apart from each other and is distributed between said bottom end and said top end of said respective spike.

5. The penetrating soil watering device according to claim 2, wherein:
said plurality of spikes includes a plurality of first spikes and a plurality of second spikes and a plurality of third spikes and a plurality of fourth spikes;
said plurality of third spikes has a length being greater than a length of said plurality of fourth spikes;
said plurality of second spikes has a length being greater than said length of said plurality of third spikes; and
said plurality of first spikes has a length being greater than said length of said plurality of second spikes.

6. The penetrating soil watering device according to claim 1, wherein:
said box has an outer wall extending between said top wall and said bottom wall;
said outer wall has a front side and a back side and a first lateral side and a second lateral side;
said pair of foot pads includes a first foot pad and a second foot pad;
each of said first foot pad and said second foot pad has a rear edge and a front edge and a first lateral edge and a second lateral edge;
said rear edge of each of said first foot pad and said second foot pad is aligned with said back side of said outer wall of said box;
said front edge of each of said first foot pad and said second foot pad is spaced from said front side of said outer wall;
said first lateral edge of said first foot pad is spaced from and is oriented parallel to said first lateral side of said outer wall of said box;
said second lateral edge of said second foot pad is spaced from and is oriented parallel to said second lateral side of said outer wall of said box; and
said second lateral edge of said first foot pad is spaced from and is oriented parallel to said first lateral edge of said second foot pad.

7. The penetrating soil watering device according to claim 6, wherein:
said first pipe has a bottom end being centrally located between said second lateral edge of said first foot pad and said first lateral edge of said second foot pad wherein said first pipe is configured to be positioned between each foot of the user when the user stands on said first foot pad and said second foot pad; and
said bottom end of said first pipe is positioned closer to said back side of said outer wall of said box than said front side of said outer wall of said box wherein said first pipe is configured to be positioned in front of the user when the user stands on said first foot pad and said second foot pad.

8. The penetrating soil watering device according to claim 1, wherein:
said box has an outer wall;
said outer wall has a front side and a back side; and
said first pipe has a top end being concavely arcuate along an axis extending between said front side and said back side of said outer wall of said box.

9. The penetrating soil watering device according to claim 8, wherein:
said penetrating soil watering device includes a cylinder having an outer surface extending between a first end of said cylinder and a second end of said cylinder;
said outer surface is coupled to said top end of said first pipe such that said top end of said first pipe conforms to curvature of said outer surface such that an axis extending between said first end and said second end is perpendicular to an axis extending between said top end of said first pipe and a bottom end of said first pipe.

10. The penetrating soil watering device according to claim 9, wherein:
said cylinder is hollow;
said cylinder has a first hole extending through said outer surface;
said first hole is aligned with said top end of said first pipe such that said an interior of said cylinder is in fluid communication with an interior of said first pipe; and
said second end of said cylinder has a second hole extending into said interior of said cylinder such that said second hole is in fluid communication with said interior of said first pipe.

11. The penetrating soil watering device according to claim 9, wherein:
said rod has a coupled end being coupled to said first end of said cylinder such that said rod is oriented to be colinear with an axis extending between said first end of said cylinder and said second end of said cylinder; and
said rod has a distal end with respect to said first end of said cylinder.

12. The penetrating soil watering device according to claim 11, wherein:
said penetrating soil watering device includes a plurality of first annular rings;
each first annular ring of said plurality of first annular rings extends around said rod;
said plurality of first annular rings is distributed from said distal end of said rod toward said coupled end of said rod wherein said plurality of first annular rings is configured to having fingers on a respective hand of the user wrapped around said plurality of first annular rings; and
said plurality of second annular rings is comprised of a resiliently compressible material wherein said plurality of second annular rings is configured to enhance comfort for the user when the fingers on the respective hand of the user are wrapped around said plurality of second annular rings.

13. The penetrating soil watering device according to claim 10, wherein said second pipe has a coupled end being coupled to said second end of said cylinder having said coupled end of said second pipe being aligned with said second hole in said second end of said cylinder wherein said coupled end of said second pipe is configured to deliver the water into said second hole such that the water flows through said first hole in said outer surface of said cylinder and into said top end of said first pipe.

14. The penetrating soil watering device according to claim 1, wherein:
said second pipe has a distal end;
said second pipe has an outside surface; and
said outside surface is threaded adjacent to said distal end of said second pipe wherein said outside surface is configured to threadably engage a hose coupler on the water source.

15. The penetrating soil watering device according to claim 1, wherein:
said second pipe has a distal end and a coupled end;
said device includes a plurality of second annular rings;
each second annular ring of said plurality of second annular rings extends around said second pipe;
said plurality of second annular rings is positioned between said distal end of said second pipe and said coupled end of said second pipe wherein said plurality of second annular rings is configured to having fingers on a respective hand of the user wrapped around said plurality of second annular rings; and
said plurality of second annular rings is comprised of a resiliently compressible material wherein said plurality of second annular rings is configured to enhance comfort for the user when the fingers on the respective hand of the user are wrapped around said plurality of second annular rings.

16. The penetrating soil watering device according to claim 15, wherein:
said water valve includes a housing having an exterior wall being continuously arcuate about a center point of said housing such that said housing has a ball shape; and
said housing is integrated into said second pipe at a point located between said plurality of second annular rings and said coupled end of said second pipe.

17. The penetrating soil watering device according to claim 16, wherein:
said housing is hollow;
said housing has an entrance extending through said exterior wall;
said entrance is in fluid communication with an interior of said second pipe wherein said entrance is configured to pass the water into said housing;
said housing has an exit extending through said exterior wall;
said exit is positioned on an opposite side of said exterior wall with respect to said entrance; and
said exit is in fluid communication with said interior of said second pipe wherein said exit is configured to pass the water out of said housing.

18. The penetrating soil watering device according to claim 17, wherein:
said exterior wall of said housing has a stem hole extending into said housing;
said stem hole is located between said entrance and said exit having said stem hole being aligned with an apex of said exterior wall with respect to said entrance and said exit;
said water valve includes a ball being rotatably positioned within said housing, said ball having a channel extending through said ball;
said ball is rotatable into a first position having said channel extending between said entrance and said exit wherein said channel is configured to pass the water from said entrance to said exit;
said ball is rotatable into a second position having said channel being offset with each of said entrance and said exit wherein said channel is configured to inhibit the water from passing from said entrance to said exit;
said valve includes a stem being coupled to said ball and extending through said stem hole in said exterior wall of said housing;
said stem has a top end being exposed with respect to said exterior wall of said housing; and
said water valve includes a lever having a lower side extending between a primary end and a secondary end of said lever; and
said lower side is coupled to said top end of said stem at a point being aligned with said primary end such that said lever is oriented perpendicular to said stem wherein said lever is configured to be gripped by the user for rotating said ball between said first position and said second position.

19. A penetrating soil watering device for watering dry spots in a grassy area, said device comprising:
a box having a top wall and a bottom wall wherein said bottom wall is configured to be placed on the ground such that a user can stand on said top wall, said box being hollow to define a water space within said box wherein said water space is configured to contain water, said box having a plurality of watering holes each extending through said bottom wall and into said water space wherein said plurality of watering holes is configured to release the water from said water space, said plurality of watering holes being arranged in a plurality of columns and rows on said bottom wall, each watering hole of said plurality of watering holes having a bounding edge being threaded;
a plurality of spikes, each spike of said plurality of spikes being releasably attachable to said bottom wall of said box wherein each spike of said plurality of spikes is configured to penetrate the ground when the user stands on said top wall of said box, each spike of said plurality of spikes being hollow such that each spike of said plurality of spikes is in fluid communication with said water space when each spike of said plurality of spikes is releasably attached to said bottom wall wherein each spike of said plurality of spikes is configured to receive the water from said water space, each spike of said plurality of spikes having a plurality of watering outlets wherein said plurality of watering outlets in each spike of said plurality of spikes is configured to release the water into the ground such that the water is delivered to roots of grass that is growing in the ground when said plurality of spikes penetrates the ground, each spike of said plurality of spikes having an outside wall extending between a top end and a bottom end of a respective spike, said top end of each of spike of said plurality of spikes being open, said outside wall of each spike of said plurality of spikes tapering between said top end and said bottom end such that said bottom end of each spike of said plurality of spikes defines a point wherein said bottom end of each spike of said plurality of spikes is configured to penetrate the ground, an outside surface of said outside wall of each spike of said plurality of spikes being threaded adjacent to said top end, said top end of each spike of said plurality of spikes being insertable into a respective one of said plurality of watering holes in said bottom wall of said box, said outside surface of said outside wall of each spike of said plurality of spikes threadably engaging said bounding edge of said respective watering hole for releasably attaching each spike of said plurality of spikes to said bottom wall of said box, each watering outlet of said plurality of watering outlets associated with a respective one of said plurality of spikes extending through said outside wall of said respective spike, said plurality of watering outlets associated with said respective spike being evenly spaced apart from each other and being distributed between said bottom end and said top end of said respective spike, said plurality of spikes including a plurality of first spikes and a plurality of second spikes and a plurality of third spikes and a plurality of fourth spikes, said plurality of third spikes having a length being greater than a length of said plurality of fourth spikes, said plurality of second spikes having a length being greater than said length of said plurality of third spikes, said plurality of first spikes having a length being greater than said length of said plurality of second spikes;
a pair of foot pads, each foot pad of said pair of foot pads being coupled to said top wall of said box wherein each foot pad of said pair of foot pads is configured to have a respective foot of the user placed upon a respective foot pad when the user stands upon said top wall of said box, each foot pad of said pair of foot pads being comprised of a friction enhancing material wherein each foot pad of said pair of foot pads is configured to inhibit the respective foot of the user from slipping on said respective foot pad when the user stands on said pair of foot pads, said pair of foot pads including a first foot pad and a second foot pad, each of said first foot pad and said second foot pad having a lower surface being coupled to a top surface of said top wall of said box such that an upper surface of each first foot pad and said second foot pad is configured to have the respective foot of the user placed upon a respective one of said first foot pad and said second foot pad when the user stands on said top wall of said box, said box having an outer wall extending between said top wall and said bottom wall, said outer wall having a front side and a back side and a first lateral side and a second lateral side, each of said first foot pad and said second foot pad having a rear edge and a front edge and a first lateral edge and a second lateral edge, said rear edge of each of said first foot pad and said second foot pad being aligned with said back side of said outer wall of said box, said front edge of each of said first foot pad and said second foot pad being spaced from said front side of said outer wall, said first lateral edge of said first foot pad being spaced from and being oriented parallel to said first lateral side of said outer wall of said box, said second lateral edge of said second foot pad being spaced from and being oriented parallel to said second lateral side of said outer wall of said box, said second lateral edge of said first foot pad being spaced from and being oriented parallel to said first lateral edge of said second foot pad;
a first pipe being coupled to and extending upwardly from said top wall of said box, said first pipe being in fluid communication with said water space in said box wherein said first pipe is configured to deliver water into said water space, said first pipe having a bottom end being centrally located between said second lateral edge of said first foot pad and said first lateral edge of said second foot pad wherein said first pipe is configured to be positioned between each foot of the user when the user stands on said first foot pad and said second foot pad, said bottom end of said first pipe being positioned closer to said back side of said outer wall of said box than said front side of said outer wall of said box wherein said first pipe is configured to be positioned in front of the user when the user stands on said first foot pad and said second foot pad, said first pipe having a top end being concavely arcuate along an axis extending between said front side and said back side of said outer wall of said box;
a cylinder having an outer surface extending between a first end of said cylinder and a second end of said cylinder, said outer surface being coupled to said top end of said first pipe such that said top end of said first pipe conforms to curvature of said outer surface such that an axis extending between said first end and said second end is perpendicular to an axis extending between said top end of said first pipe and said bottom end of said first pipe, said cylinder being hollow, said cylinder having a first hole extending through said outer surface, said first hole being aligned with said top end of said first pipe such that said an interior of said cylinder is in fluid communication with an interior of said first pipe, said second end of said cylinder having a second hole extending into said interior of said cylinder such that said second hole is in fluid communication with said interior of said first pipe;
a rod being disposed on said first pipe such that said rod is spaced upwardly from said box, said rod being oriented perpendicular to said first pipe wherein said rod is configured to be gripped with a respective hand of the user when the user stands on said pair of foot pads, said rod having a coupled end being coupled to said first end of said cylinder such that said rod is oriented to be colinear with an axis extending between said first end of said cylinder and said second end of said cylinder, said rod having a distal end with respect to said first end of said cylinder;
a plurality of first annular rings, each first annular ring of said plurality of first annular rings extending around said rod, said plurality of first annular rings being distributed from said distal end of said rod toward said coupled end of said rod wherein said plurality of first annular rings is configured to having fingers on a respective hand of the user wrapped around said plurality of first annular rings, said plurality of first annular rings being comprised of a resiliently compressible material wherein said plurality of first annular rings is configured to enhance comfort for the user when the fingers on the respective hand of the user are wrapped around said plurality of first annular rings;
a second pipe being disposed on said first pipe such that said second pipe is spaced upwardly from said box, said second pipe being oriented perpendicular to said first pipe wherein said second pipe is configured to be gripped with a respective hand of the user when the user stands on said pair of foot pads, said second pipe being attachable to a water source wherein said second pipe is configured to receive water from the water source, said second pipe being in fluid communication with said first pipe wherein said second pipe is configured to deliver the water into said first pipe, said second pipe having a coupled end being coupled to said second end of said cylinder having said coupled end of said second pipe being aligned with said second hole in said second end of said cylinder wherein said coupled end of said second pipe is configured to deliver the water into said second hole such that the water flows through said first hole in said outer surface of said cylinder and into said top end of said first pipe, said second pipe having a distal end with respect to said second end of said cylinder, said second pipe having an outside surface, said outside surface being threaded adjacent to said distal end of said second pipe wherein said outside surface is configured to threadably engage a hose coupler on the water source;
a plurality of second annular rings, each second annular ring of said plurality of second annular rings extending around said second pipe, said plurality of second annular rings being positioned between said distal end of said second pipe and said coupled end of said second pipe wherein said plurality of second annular rings is configured to having fingers on a respective hand of the user wrapped around said plurality of second annular rings, said plurality of second annular rings being comprised of a resiliently compressible material wherein said plurality of second annular rings is configured to enhance comfort for the user when the fingers on the respective hand of the user are wrapped around said plurality of second annular rings; and
a water valve being integrated into said second pipe, said water valve being actuatable into a closed condition wherein said water valve is configured to inhibit the water from flowing through said water valve to inhibit the water from flowing into said first pipe, said water valve being actuatable into an open condition wherein said water valve is configured to allow the water to flow through said water valve such that the water can flow into said first pipe, said water valve comprising:
a housing having an exterior wall being continuously arcuate about a center point of said housing such that said housing has a ball shape, said housing being integrated into said second pipe at a point located between said plurality of second annular rings and said coupled end of said second pipe, said housing being hollow, said housing having an entrance extending through said exterior wall, said entrance being in fluid communication with an interior of said second pipe wherein said entrance is configured to pass the water into said housing, said housing having an exit extending through said exterior wall, said exit being positioned on an opposite side of said exterior wall with respect to said entrance, said exit being in fluid communication with said interior of said second pipe wherein said exit is configured to pass the water out of said housing, said exterior wall having a stem hole extending into said housing, said stem hole being located between said entrance and said exit having said stem hole being aligned with an apex of said exterior wall with respect to said entrance and said exit;
a ball being rotatably positioned within said housing, said ball having a channel extending through said ball, said ball being rotatable into a first position having said channel extending between said entrance and said exit wherein said channel is configured to pass the water from said entrance to said exit, said ball being rotatable into a second position having said channel being offset with each of said entrance and said exit wherein said channel is configured to inhibit the water from passing from said entrance to said exit;
a stem being coupled to said ball and extending through said stem hole in said exterior wall of said housing, said stem having a top end being exposed with respect to said exterior wall; and
a lever having a lower side extending between a primary end and a secondary end of said lever, said lower side being coupled to said top end of said stem at a point being aligned with said primary end such that said lever is oriented perpendicular to said stem wherein said lever is configured to be gripped by the user for rotating said ball between said first position and said second position.
